(19) United States
(12) Patent Application Publication
(10) Pub. No.: US 2012/0136718 A1
(43) Pub. Date: May 31, 2012

(54) Display of Search Ads in Local Language

(75) Inventor: Anand N. Katti, Bangalore (IN)

(73) Assignee: MICROSOFT CORPORATION, Redmond, WA (US)

(21) Appl. No.: 12/955,601

(22) Filed: Nov. 29, 2010

(51) Int. Cl. G06Q 30/00

(52) U.S. Cl. 705/14.49

(57) ABSTRACT

Systems, methods, and computer media for providing search results that include advertisements in a local language are provided. Upon receiving a user search query in a first language, a local language associated with the user search query is identified. One or more web pages that are relevant to the user search query are identified. The identified web pages are in the first language. One or more advertisements relevant to the user search query are also identified. The identified advertisements are configured to display in the local language. Search results are then provided that incorporate identified links to relevant web pages in the first language and identified advertisements configured to display in the local language.

### BACKGROUND

Internet searching has become increasingly common in recent years. Users typically enter a search keyword or phrase, and search providers return ranked search results that may include a hyperlink to a relevant web page and a text summary of the content found on the web page. Search providers also typically include search ads, also known as sponsored links or sponsored sites, in returned search results.

As search providers make search engines available to users in countries worldwide, a number of issues have arisen. One such issue is that search ads incorporated into the returned search results are conventionally presented only in English, regardless of context. In countries where languages other than English are commonly spoken, presenting search ads in English only reaches a portion of the searching population and limits opportunities for smaller, local businesses to take advantage of the reach and low cost of Internet advertising.

### SUMMARY

Embodiments of the present invention relate systems, methods, and computer media for providing search advertisements in a local language. Using the methods described herein, a user search query in a first language can be received. A local language associated with the user search query can be identified. One or more web pages in the first language relevant to the user search query can also be identified. Additionally, one or more advertisements relevant to the user search query can be identified. The identified advertisements are configured to display in the local language. A search result can then be provided incorporating links to one or more of the identified web pages and one or more of the identified advertisements configured to display in the local language.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of a prior art search results web page including search results in a first language and search advertisements in English;

FIG. 3 is a block diagram of an exemplary system for providing search advertisements in a local language;

FIG. 4 is a block diagram of an exemplary search results web page including search results in a first language and search advertisements in a local language;

FIG. 5 is a flow chart of an exemplary method for providing search advertisements in a local language;

FIG. 6 is a flow chart illustrating an exemplary embodiment of step 504 of FIG. 5; and

FIG. 7 is a flow chart of an exemplary method for providing at least one search advertisement in a first local language and at least one search advertisement in a second local language.

### DETAILED DESCRIPTION

Embodiments of the present invention are described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” or “module” etc. might be used herein to connote different components of methods or systems employed, the terms should not be interpreted as implying any particular order among or between various steps herein disclosed unless and except when the order of individual steps is explicitly described.

Embodiments of the present invention provide systems, methods, and computer media for providing search advertisements in a local language. When a user search query is received, relevant web pages and paid search advertisements are identified and included in a search results web page. In accordance with embodiments of the present invention, the paid search advertisements included in the search results web page are configured to display in a local language. Conventionally, paid search ads are displayed in English, regardless of the search context.

When a user query is performed in a country in which other or additional languages are commonly spoken, however, providing the search ads in a local language allows advertisers the opportunity to reach customers who may not speak much or any English. Smaller, local businesses who may not have the need, desire, or ability to advertise in English are able to take advantage of the reach and low cost of Internet advertising. Advertisers can configure search advertisements to display in one or more particular local languages. When a user search query is received, a local language can be identified based on information associated with the query. Search ads configured to display in the local language can be identified in an advertising system and incorporated into a search results page. As used herein, “language” includes both recognized languages (e.g., English, French, Spanish, Japanese, etc.) and dialects and regional variations of recognized languages.

In accordance with embodiments of the present invention, a user search query in a first language is received. A local language associated with the user search query is identified. One or more web pages in the first language relevant to the user search query are identified. One or more advertisements relevant to the user search query that are configured to display in the local language are also identified. A search result is then provided that incorporates links to one or more of the identified web pages and one or more of the identified advertisements configured to display in the local language.

In another embodiment, an intake component receives a user search query in a first language. A search component identifies one or more web pages in the first language relevant to the user search query. A local language component identifies a local language associated with the received user search query. An advertising component identifies one or more advertisements relevant to the user search query that are configured to display in the local language. An integration component provides a search result incorporating links to one or more of the identified web pages and one or more of the identified advertisements configured to display in the local language.

In still another embodiment, a user search query in a first language is received. Two or more local languages other than English that are different from the first language and are associated with the user search query are identified. The identification of each local language is based on at least one of: a location corresponding to the IP address from which the user search query is sent; a location corresponding to a term in the user search query; or a language of at least one term in the user search query. One or more web pages in the first language relevant to the user search query are identified.

Two or more advertisements relevant to the user search query are also identified. At least one advertisement is configured to display in a first identified local language, and at least one advertisement is configured to display in a second identified local language. A search result is provided incorporating: links to one or more of the identified web pages; at least one advertisement configured to display in the first identified local language; and at least one advertisement configured to display in the second identified local language.

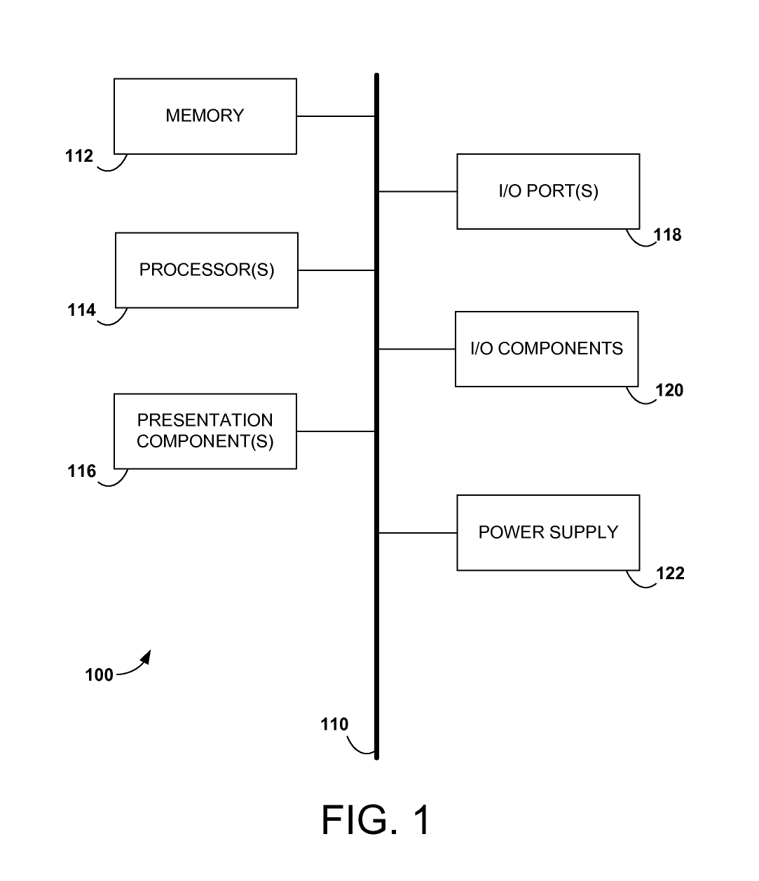

Having briefly described an overview of some embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of embodiments of the present invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the present invention may be practiced in a variety of system configurations, including hand-held devices, consumer electronics, general-purpose computers, more specialty computing devices, etc. Embodiments of the present invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

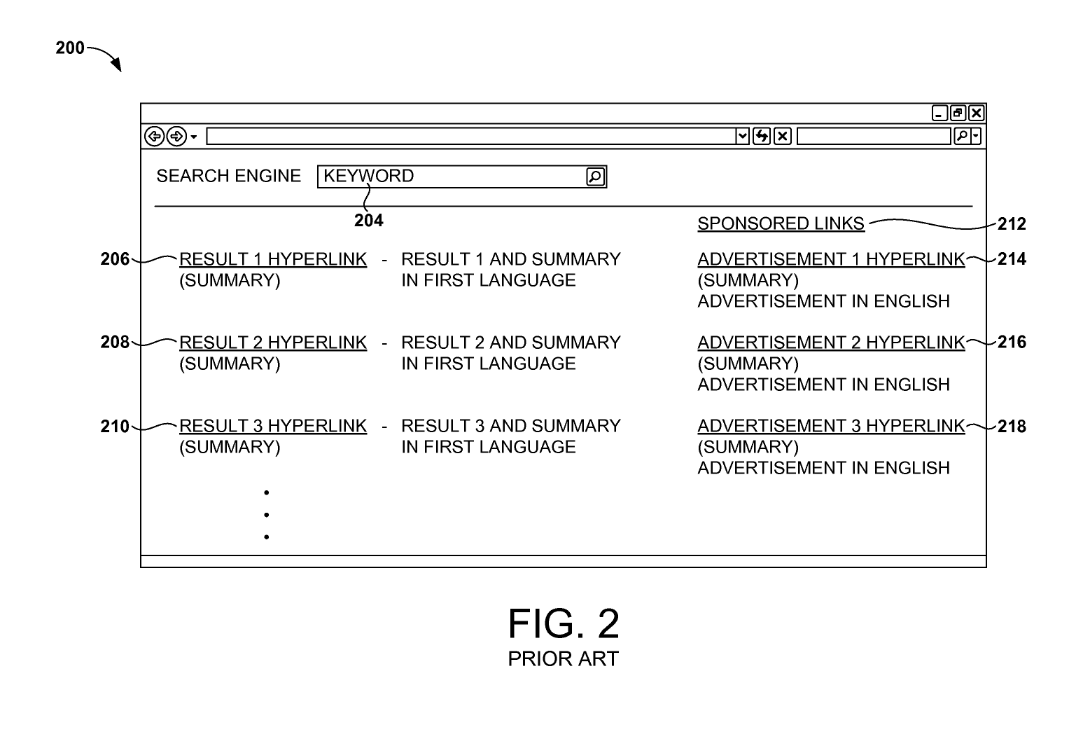

As discussed previously, embodiments of the present invention provide systems, methods and computer media for providing search advertisements in a local language. Embodiments of the present invention will be discussed with reference to FIGS. 2-7.

FIG. 2 illustrates a prior art search results page 200. A user keyword search has been performed for keyword 204. Keyword 204 is in a first language. Search results 206, 208, and 210 have been identified as relevant and included in search results page 200. Each of search result 206, 208, and 210 is in the first language and includes a hyperlink to a corresponding identified web page and a summary of the content of the web page. The first language may be English or another language.

Prior art search results page 200 also includes a search advertisements or “sponsored links” section 212. Each of search ads 214, 216, and 218 contains a hyperlink and summary. Search ads 214, 216, and 218 are displayed in English regardless of whether the first language is English or another language. Thus, if keyword 204 is in English, search results 206, 208, and 210 and search ads 214, 216, and 218 are displayed in English. If keyword 204 is, for example, in German, search results 206, 208, and 210 may be in German, but search ads 214, 216, and 218 are still displayed in English.

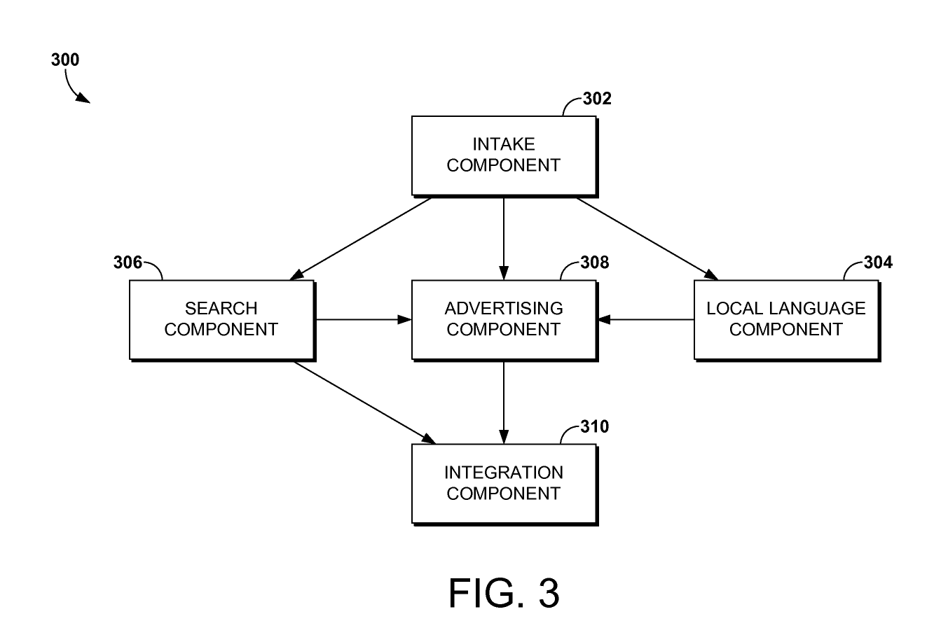

FIG. 3 is a block diagram of a system 300 for providing search ads in a local language. Intake component 302 receives a user search query. The user search query is in a first language, which may be English or any other language. The search query may be a keyword, phrase, image, or any other input accepted by the particular search engine.

Local language component 304 identifies a local language associated with the received user query. Search ads configured to display in the identified local language can be included in a search results page. In some embodiments, multiple local languages are identified. The local language can be identified based on a variety of information associated with the received user query. In one embodiment, a location is identified that corresponds to the IP address from which a user search query is received. The local language is then identified as a language commonly spoken in the identified location. For example, if a user search query is determined to originate from an IP address in Mexico City, Spanish might be identified as the local language, although other local languages might also be identified. The IP address can be identified through IP address detection or other methods.

In other embodiments, a location corresponding to a term in the user search query is identified. The local language is then identified as a language commonly spoken in the identified location. For example, the user search query might include the word “Paris” or “France.” These terms would then be used to identify the locations Paris or France, and the local language could be identified as French, although other local languages could also be identified.

In still further embodiments, the language of at least one term in the user search query is used to identify a local language. For example, if it is recognized that a Japanese word is included in the query, Japanese can be identified as the local language. Similarly, if a term in the query is in a first local language, a second local language commonly spoken where the first local language is commonly spoken can be identified as the local language. For example, if a user search query includes a term recognized to be in Kannada, the local language could be identified as: (1) Kannada, because a search term was recognized as being in that language; or (2) another language such as Telugu that is also spoken in some areas where Kannada is spoken.

In some embodiments, multiple local languages are identified. Although multiple local languages may be identified regardless of the type of information used to make the identification, identification of multiple local languages may be especially useful when location information is used to identify the local languages. Consider, for example, a user search query identified as received from an IP address in Bangalore, India. Kannada, Telugu, Tamil, and Hindi are all spoken to some degree in the Bangalore area. In such a situation, it can be useful for local language component 304 to identify all four of these local languages. In some embodiments, only the most widely spoken one or two local languages are identified. In other embodiments, all local languages having a number of speakers above a threshold in an identified area are selected. In still other embodiments a particular number of local languages are selected.

Search component 306 identifies one or more web pages in the first language that are relevant to the user search query (which is also in the first language). One or more of the identified web pages are included in search results provided to the user. The identification of relevant web pages may be accomplished through a variety of known techniques including accessing and searching a web index created by spidering the Internet.

Advertising component 308 identifies one or more advertisements relevant to the user search query that are configured to display in the local language. An advertising system is in communication with or part of a search system. Relevant search advertisements can be identified for inclusion in search results provided to the user. When advertisers create campaigns or ads, the ads may be either created in one or more local languages or designated to display in one or more local languages. In some embodiments, a search ad is configured to display only in one of a number of local languages at a time. In embodiments where an identified search advertisement is configured to display in multiple local languages, the local language in which the advertisement is actually displayed depends upon the local language identified by local language component 304.

Advertisers may also specify that particular ads display in both English and a non-English local language. Advertising component 308 can search the advertising system and identify search ads configured to display in the local language. In some embodiments, advertising component 308 identifies one or more search ads configured to display in each identified local language. In some embodiments, advertising component 308 identifies one or more search advertisements configured to display in an identified local language and one or more search advertisements configured to display in English.

In some embodiments, advertisers may configure search ads to display in languages that are obscure or uncommon for an identified location. For example, a particular advertiser may identify a group of people that speak a particular language as exceptionally interested in purchasing a particular product. The advertiser might configure a search ad to display in that particular language when a location is identified, regardless of how common the language is in the identified location. In such a case, the advertiser is essentially wagering that a high success rate for users who understand the language will outweigh the fact that few users in the identified location will understand the ad.

Integration component 310 provides a search result incorporating links to one or more of the relevant web pages identified by search component 306 and one or more of the search advertisements configured to display in a local language identified by advertising component 308. The search result may be provided as a web page.

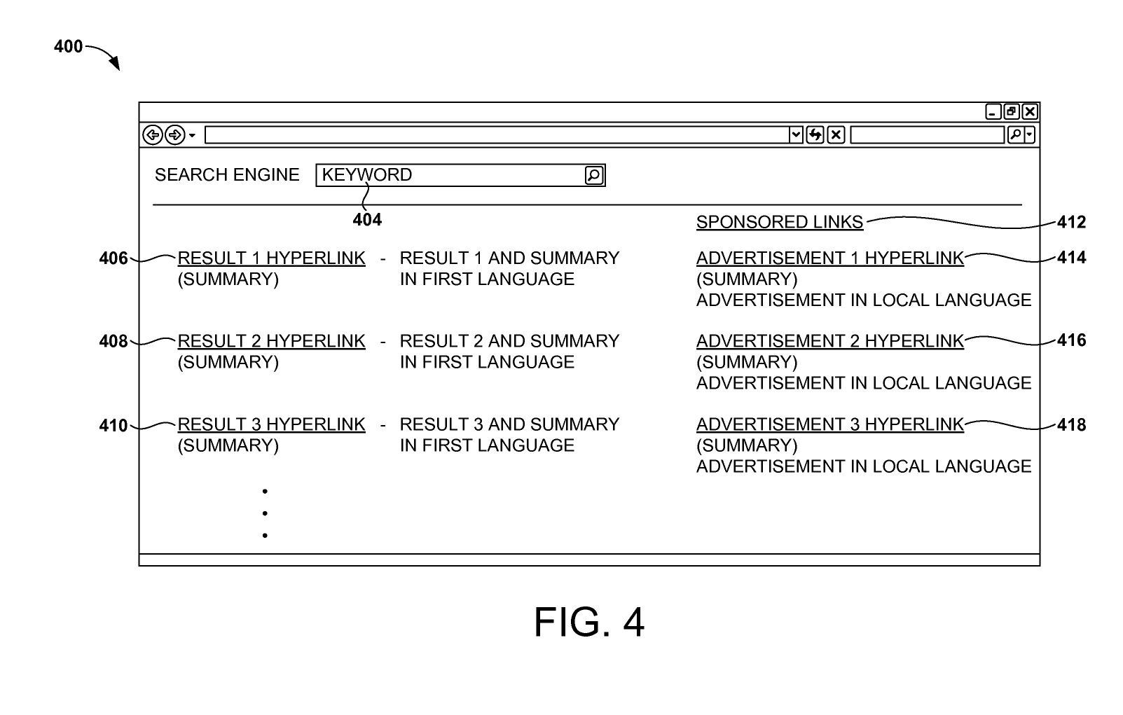

FIG. 4 illustrates an exemplary search results web page 400 that can be provided by integration component 310 of FIG. 3. A user search query for keyword 404 has been performed. Keyword 404 is in a first language. Search results 406, 408, and 410 have been identified as relevant to keyword 404 and are included in search results page 400. Each of search results 406, 408, and 410 is in the first language, which may be English or another language.

Search results page 400 also includes a search advertisements or “sponsored links” section 412. Each of search ads 414, 416, and 418 is displayed in a local language other than English. The first language in which search results 406, 408, and 410 are displayed may be English or any other language. If the first language is a language other than English, the first language may be the same as the local language. The first language may also be a language other than English that is different than the local language. In some embodiments, search ads are configured to simultaneously display in multiple local languages or in a local language and English.

Search advertisements in the local language may relate to a festival season or custom celebrated in a location associated with the local language. Many small or local businesses may wish to advertise particular specials, products, events, and/or extended hours during a festival or other celebration period. Search ads configured to display in English would in many cases not reach the intended audience. Providing search ads in the corresponding local language allows the local businesses to take a targeted approach to reaching local customers who may not speak much or any English and take advantage of the low cost of Internet advertising.

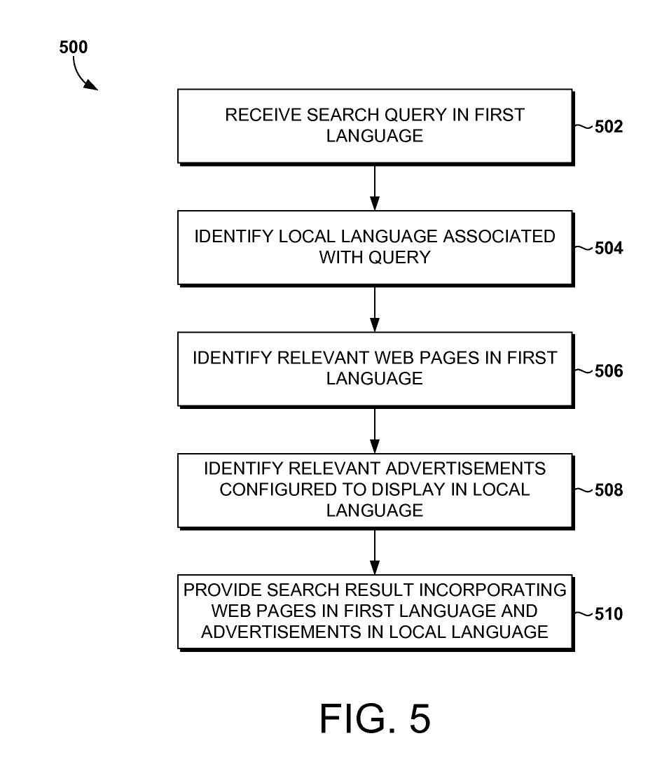

FIG. 5 illustrates an exemplary method 500 for providing search ads in a local language. In step 502, a search query in a first language is received. In step 504, a local language associated with the query is identified. In step 506, relevant web pages in the first language are identified. In step 508, relevant search advertisements configured to display in the local language are identified. Search results are provided in step 510 that incorporate identified relevant web pages in the first language and relevant search ads in the local language.

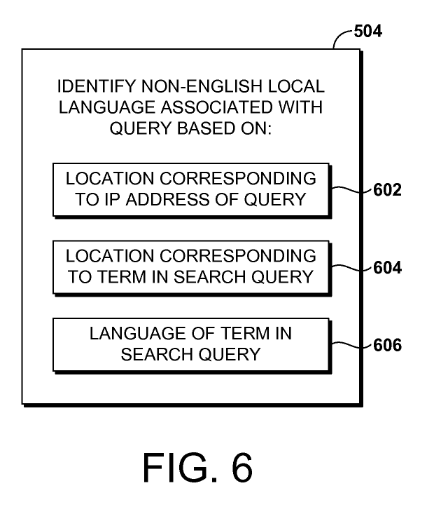

In some embodiments, identification of the local language in step 504 of method 500 is performed as illustrated in FIG. 6. In FIG. 6, a non-English local language associated with the query is identified based on any one or combination of: a location corresponding to the IP address from which the search query is sent; a location corresponding to a term in the user search query; and a language of at least one term in user search query.

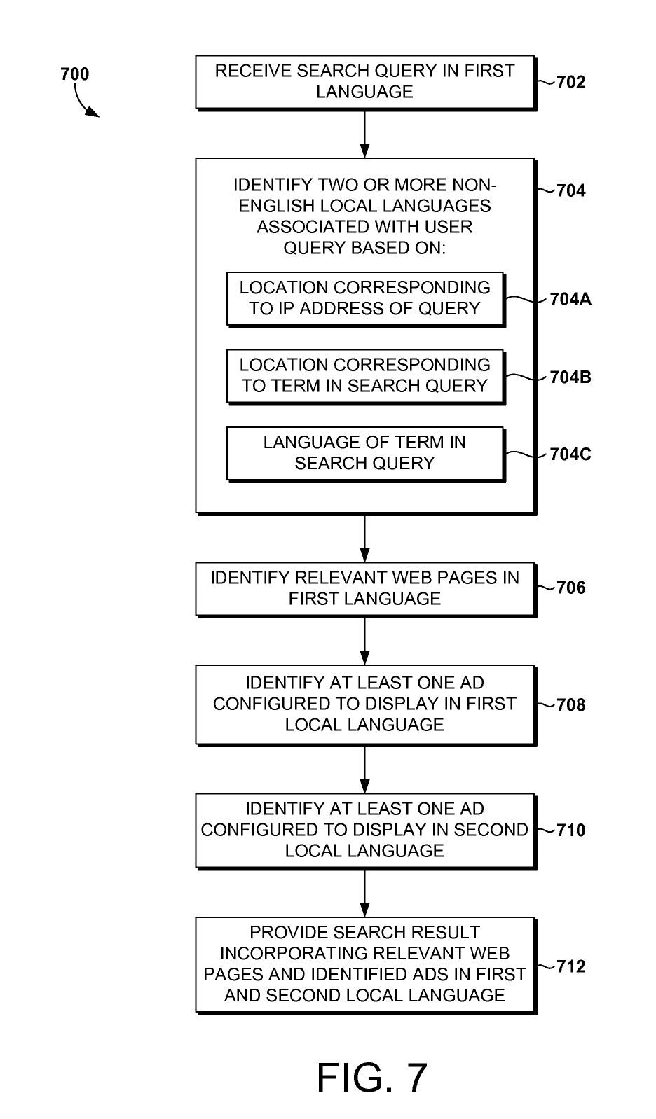

FIG. 7 illustrates another exemplary method 700 for providing search ads in a local language. In step 702, a search query in a first language is received. In step 704, two or more non-English local languages associated with the user query are identified. The two or more non-English local languages may be identified based on one or more of: a location corresponding to the IP address from which the search query is sent (704A); a location corresponding to a term in the user search query (704B); and a language of at least one term in user search query (704C).

In step 706, relevant web pages in the first language are identified. In step 708, at least one search ad configured to display in the first local language is identified. In step 710, at least one search ad configured to display in the second local language is identified. In step 712, a search result is provided that incorporates relevant web pages identified in step 706 and search ads identified in steps 708 and 710.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

Having thus described the invention, what is claimed is:

1. One or more computer storage media storing computer-executable instructions for performing a method for providing search advertisements in a local language, the method comprising:
receiving a user search query in a first language;
identifying a local language associated with the user search query;
identifying one or more web pages in the first language relevant to the user search query;
identifying one or more advertisements relevant to the user search query, the advertisements configured to display in the local language; and
providing a search result incorporating links to one or more of the identified web pages and one or more of the identified advertisements configured to display in the local language.

2. The media of claim 1, wherein the identification of the local language is based on a location corresponding to the IP address from which the search query is sent.

3. The media of claim 1, wherein the identification of the local language is based on a location corresponding to a term in the user search query.

4. The media of claim 1, wherein the identification of the local language is based on a language of at least one term in user search query.

5. The media of claim 1, wherein the incorporated advertisements configured to display in the local language relate to a festival season or custom celebrated in a location associated with the local language.

6. The media of claim 1, wherein the incorporated advertisements configured to display in the local language are also configured to simultaneously display in the first language.

7. The media of claim 1, wherein the incorporated advertisements configured to display in the local language are configured to display in multiple local languages, and wherein the local language in which the advertisements are displayed depends upon the identified local language.

8. The media of claim 1, wherein the local language is a language other than English, and wherein the first language and the local language are different languages.

9. The media of claim 1, wherein the local language is a language other than English, and wherein the first language and the local language are the same language.

10. One or more computer storage media having a system embodied thereon including computer-executable instructions that, when executed, perform a method for providing search advertisements in a local language, the system comprising:
an intake component that receives a user search query, the user search query in a first language;
a search component that identifies one or more web pages in the first language relevant to the user search query;
a local language component that identifies a local language associated with the received user search query;
an advertising component that identifies one or more advertisements relevant to the user search query, the advertisements configured to display in the local language; and
an integration component that provides a search result incorporating links to one or more of the identified web pages and one or more of the identified advertisements configured to display in the local language.

11. The media of claim 10, wherein the local language component identifies the local language based on a location corresponding to the IP address from which the search query is sent.

12. The media of claim 10, wherein the local language component identifies the local language based on a location corresponding to a term in the search query.

13. The media of claim 10, wherein the local language component identifies the local language based on the language of at least one search term in the user search query.

14. The media of claim 10, wherein the advertisements incorporated by the integration component and configured to display in the local language relate to a festival season or custom celebrated in a location associated with the local language.

15. The media of claim 10, wherein the advertisements incorporated by the integration component and configured to display in the local language are also configured to simultaneously display in the first language.

16. The media of claim 10, wherein the local language is a language other than English, and wherein the first language and the local language are different languages.

17. The media of claim 10, wherein the local language is a language other than English, and wherein the first language and the local language are the same language.

18. One or more computer storage media storing computer-executable instructions for performing a method for providing search advertisements in a local language, the method comprising:
receiving a user search query in a first language;
identifying two or more local languages other than English that are different from the first language and are associated with the user search query, the identification of each local language based on at least one of:
a location corresponding to the IP address from which the user search query is sent,
a location corresponding to a term in the user search query, or
a language of at least one term in the user search query;
identifying one or more web pages in the first language relevant to the user search query;
identifying two or more advertisements relevant to the user search query, at least one advertisement configured to display in a first identified local language, and at least one advertisement configured to display in a second identified local language; and
providing a search result incorporating: links to one or more of the identified web pages; at least one advertisement configured to display in the first identified local language; and at least one advertisement configured to display in the second identified local language.

19. The media of claim 18, wherein the incorporated advertisements configured to display in the local language relate to a festival season or custom celebrated in a location associated with the local language.

20. The media of claim 18, wherein the incorporated advertisements are also configured to simultaneously display in the first language.
